(19) United States
(12) Patent Application Publication
(10) Pub. No.: US 2007/0198324 A1
(43) Pub. Date: Aug. 23, 2007

(54) Enabling connections between and events attended by people

(76) Inventors: Richard D. Borovoy, Boston, MA (US); George Eberstadt, Boston, MA (US); Rahul Bhargava, Cambridge, MA (US); George Kao, Holliston, MA (US)

Correspondence Address: FISH & RICHARDSON PC, P.O. BOX 1022, MINNEAPOLIS, MN, 55440-1022, US

(21) Appl. No.: 11/359,878

(22) Filed: Feb. 22, 2006

(51) Int. Cl. G06F 17/30

(52) U.S. Cl. 705/10

(57) ABSTRACT

Through a user interface on a computer, a user is enabled to define questions to be answered by attendees of an event, the answers to the questions being indicative of connections corresponding to pairs of attendees, a computer receives answers to the questions from the attendees through a user interface, and based on the answers, provides information to attendees to facilitate face-to-face interaction between the pairs of attendees. Through a user interface on a computer, a user is enabled to view a graphical device that is representative of a current satisfaction of attendees of an event based on two or more factors associated with satisfaction while the event is occurring.

### BACKGROUND

This description relates to enabling connections between and events attended by people.

Several years ago, nTAG Interactive Corporation developed an interactive tag to be worn around the neck of an attendee at a convention. This tag is able to electronically communicate with tags worn by other attendees, for example, when the attendees face each other. The tags (also sometimes called badges) can exchange data electronically even before the two attendees have a chance to talk to each other. The data can carry information about what the two attendees have in common. The tags also can communicate wirelessly with readers, such as RFID readers or WiFi or WiMax transceivers. These tags are described in U.S. patent application Ser. No. 10/396,064, filed Mar. 24, 2003, and Ser. No. 10/729,696, filed Dec. 5, 2003, both entitled Apparatus and Method for Enhancing Face-to-Face Communication, incorporated here by reference. They are also described in U.S. patent application Ser. No. 11/069,716, filed Feb. 28, 2005, entitled Method of Scoring the Performance of Attendees at a Meeting, also incorporated here by reference.

### SUMMARY

In general, in one aspect, through a user interface on a computer, a user is enabled to define questions to be answered by attendees of an event, the answers to the questions being indicative of connections corresponding to pairs of attendees, a computer receives answers to the questions from the attendees through a user interface, and based on the answers, provides information to attendees through a computer to facilitate face-to-face interaction between the pairs of attendees.

In general, in one aspect, through a user interface on a computer, an attendee of an event is enabled to provide answers to questions, the answers being indicative of connections of attendees to other attendees of the event, and the attendee is enabled to view, through the user interface, connections of the attendee to other attendees who have been selected based on connections indicated by answers of the attendees to the questions.

In general, in one aspect, through a user interface on a computer, a user is enabled to define a putative connection between attendees of an event, the putative connection corresponding to an objective of the event, and a computer determines actual connections between attendees of the event corresponding to the putative connection based on information provided by the attendees.

In general, in one aspect, a user is enabled, through a user interface on a computer, to define connections between attendees of an event that will enhance a measure of success of the event, and based on the defined connections, cause electronic badges worn by the attendees at the event to facilitate the defined connections.

In general, in one aspect, through a user interface on a computer, a user is enabled to view a graphical device that is representative of a current satisfaction of attendees of an event based on two or more factors associated with satisfaction while the event is occurring.

Implementations may include the feature that the graphical device illustrates performance against the two or more factors in a single integrated graphical representation.

In general, in one aspect, a computer receives an identification of a relationship between values, receives an identification of an attribute, determines that a person is associated with a value of the attribute having the identified relationship, and on the basis of the determination, identifies the person as belonging to a group.

Implementations may include one or more of the following features. Determining includes determining that the person is associated with the same value of the attribute as another person. Determining includes determining that the person is associated with a different value of the attribute than another person. Determining includes determining that the person is associated with a specific value of the attribute. The specific value of the attribute is based on a value of the attribute associated with another person.

In general, in one aspect, a computer, provides a user interface that allows a user to identify a relationship between values, and identify a relationship.

In general, in one aspect, a computer provides a user interface that allows a user to associate values of attributes with the user, and displays to the user other users based on the values of attributes and on values of attributes associated with the other users.

In general, in one aspect, a computer receives first information about behavior of people, receives second information about a correlation of behavior of people to a first measurement, based on the first information and the second information, predicts a value of the first measurement, and displays the first information, the predicted value, and a relationship between the first information and the predicted value.

Implementations may include one or more of the following features. The first information includes at least two second measurements, the second information includes an indication that at least one of the second measurements is correlated to the first measurement, and displaying the relationship includes indicating which of the second measurements is correlated to the first measurement. The second information includes an indication that on prior occasions, groups of people were associated with at least two different values of the first measurement, and the groups of people associated with different values of the first measurement were associated with different values of at least one of the second measurements.

Other features and advantages will be apparent from the following description and the claims.

### DESCRIPTION

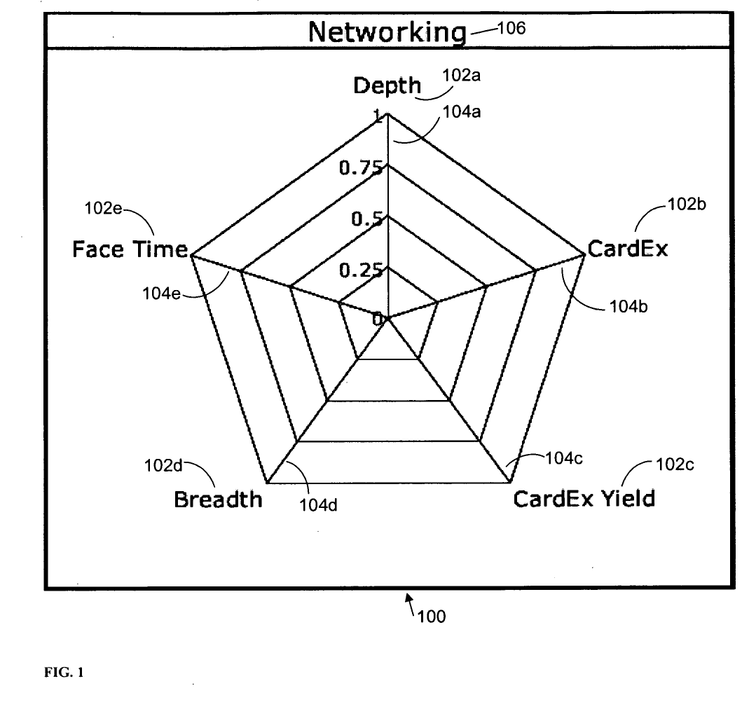

FIGS. 1-5B are graphs of event data.

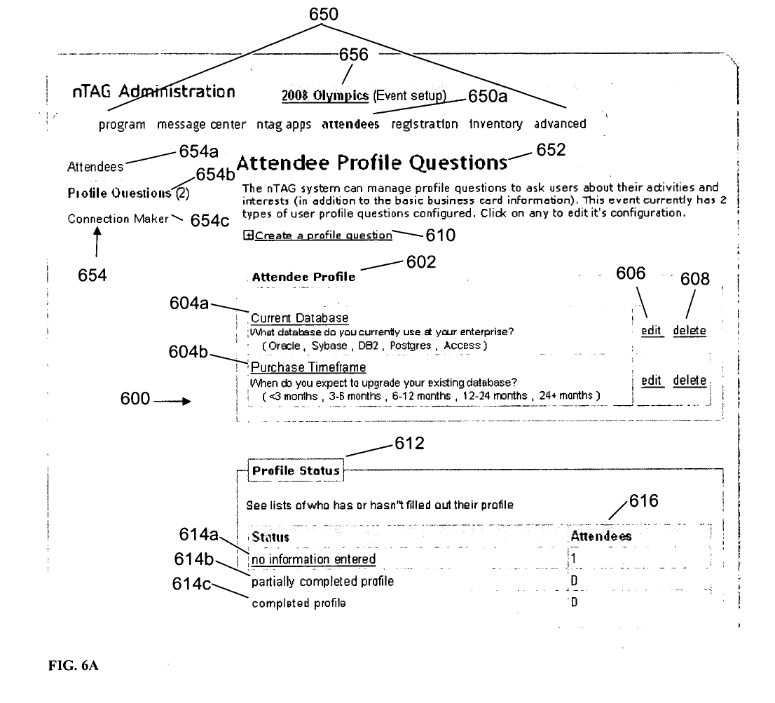

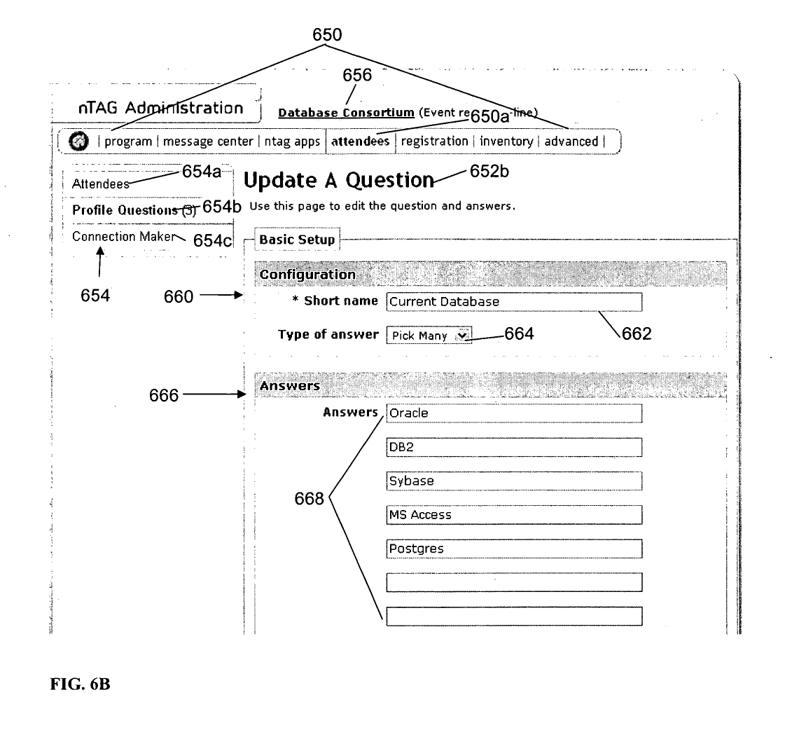

FIGS. 6A-9B are screen shots of user interfaces.

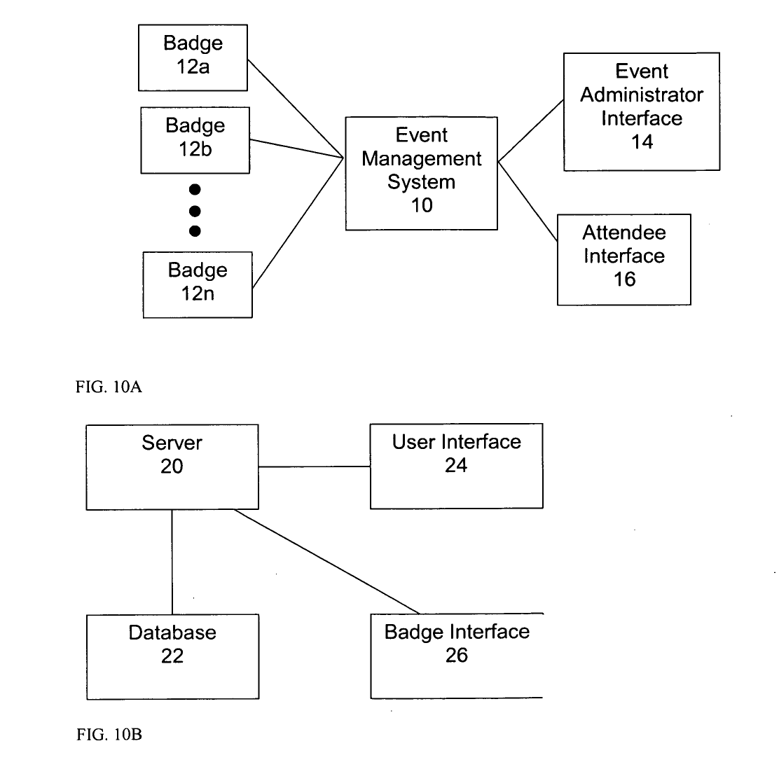

FIGS. 10A and 10B are block diagrams.

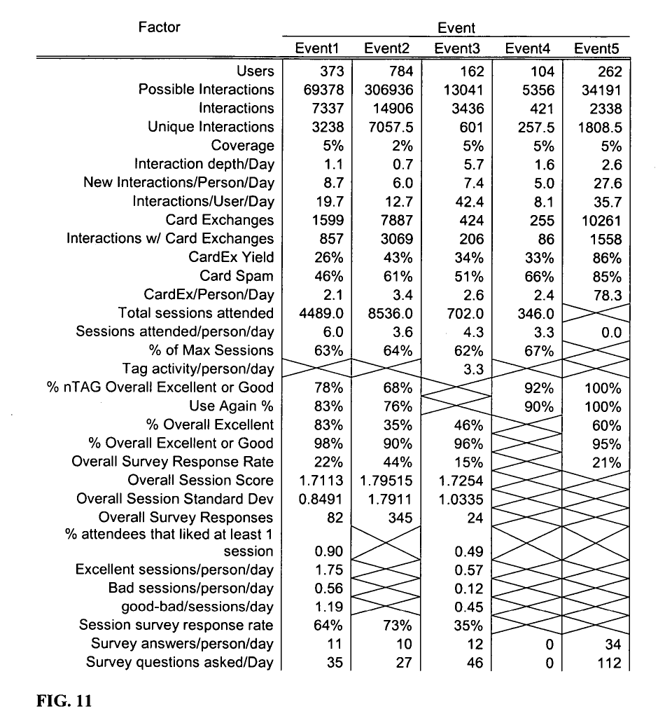

FIG. 11 is a table of data.

A convention is one example of a wide variety of events at which effective fact-to-face interactions among people can be important. Such events can includes meetings, parties, training sessions, cruises, conferences, shows, educational forums, and governmental sessions, to name a few. Events often have hosts, organizers, or operators who have certain goals or objectives in terms of human interactions that they aim to foster. For example, a sponsor of an electronics show may want to maximize the number of visits by attendees to vendor booths. A sponsor of a sales meeting may want to facilitate interactions of salesmen with prospects. In the case of a large party, the host may measure the success of the event simply on an average overall satisfaction of people who attended.

The badges mentioned above can be used to provide information to attendees of an event, allow the attendees to exchange information, for example, virtual business cards, and enable an event organizer to monitor interactions between attendees. The badges also enable the event organizer to poll the attendees and collect information about their satisfaction with the event. Specific features include attendance tracking, surveys, networking activity, lead capture, and audience response.

In analyzing data collected at events using the badges, it has been found that certain activities, behaviors, and attitudes correlate with very high satisfaction by event attendees. An event organizer can obtain information about some of these factors by analyzing the interactions among attendees recorded by the badges. Five such factors are described in Table 1. Other factors, such as those listed in Table 2, can be derived from attendee participation in conference sessions, workshops, or similar activities that can be run independently or as part of events.

TABLE 1

| | |
|---|---|
| Face Time | Average amount of time per day that an attendee |
| | spent talking to another attendee |
| Breadth | Average number of different attendees per day |
| | with whom an attendee spoke |
| Depth | Average length of an attendee conversation |
| Card Exchanges | Average number of virtual business card |
| | exchanges per attendee per day |
| Card Exchange | Average percent of conversations that resulted in |
| Yield | card exchange |

TABLE 2

| | |
|---|---|
| Attendance | Average number of sessions attended per |
| | attendee per day |
| Net Positive | Average number of “hit sessions” minus number |
| Impressions | of “turkey sessions” per person per day |
| Average Score | Average of “overall” ratings for each session |
| Response Rate | Percent of session surveys answered |
| Data Volume | Average amount of survey questions answered |
| | per person per day |

The data used to assign values to each of these factors are collected by the badges in several ways. When two attendees are facing each other, and presumably interacting, their respective badges sense each other and each record the identity of the other party, as reported by his badge, and the duration of their interaction. This information is used to compute factors such as those in Table 1. For example, Face Time is computed from the total time of all interactions, divided by the number of attendees. Depth is based on the same total, divided by the number of interactions. Breadth is based on the number of different attendees' badges each badge reports interacting with. Card Exchanges and Card Exchange Yield are based on how much attendees use a feature of the badges that allows them to exchange virtual business cards.

Factors related to attendance at sessions, such as those in Table 2, are based on features of the badges that allow attendance to be taken and feedback received through the badges. After attending a session, attendees may be asked to complete a survey about the session on their badge. Net Positive Impressions and Average Score are based on the substance of the responses, while Response Rate and Data Volume are based on how manu attendees actually complete their surveys. Although many of the factors are expressed “per day,” other periods could be used for the measurement.

As shown in FIG. 10A, an event management system 10 provides this information through an event administrator interface 14 to event organizers during an event, as it is collected from the badges 12A . . . 12N, for example. The above-referenced applications describe how this data is collected and made available to the event management system. The event administrator interface 14 and an attendee interface 16 may be provided by a console on the computer hosting the event management system 10 or may be provided over a network, for example, through a web page on the Internet. The event management system has several components, as shown in FIG. 10B. These include a server 20, a database 22, and facilities 26 for interfacing with the badges. A user interface 24 generates the event administrator interface 14 and the attendee interface 16. Some of all of these components may be integrated into a single computer system, or they may be distributed over a number of computer systems and specialized hardware, in some examples, redundantly.

The information provided by the interface can be valuable to event organizers, because it enables them to respond rapidly in real time, and in particular during the event itself, to anything that might diminish attendee satisfaction with the event. An example of the information collected over five events is shown in FIG. 11. Such information is especially useful if it is presented to the event organizers at a time and in a manner that allows them to quickly understand it and identify which factors are responsible for positive or negative measurements of satisfaction. The information can also be valuable after an event is completed to allow organizers to evaluate what went well in terms of interaction of attendees and what did not and to make appropriate changes to other events. In addition to reporting this information to event organizers during the event itself, it can be stored and accumulated over multiple events, as in FIG. 11, allowing more detailed analysis and a larger sample on which to base such analysis.

FIG. 1 shows an example of how factors, like those in FIG. 11, that influence attendee satisfaction may be visualized and presented by the user interface of the event management system. In a radar graph 100, five factors 102a-e are selected and each is assigned to one spoke 104a-e of the graph. In the example of FIG. 1, these factors 102a-e correspond to the factors in Table 1, above. Each factor will be given a percentile ranking. Fiftieth percentile (0.5 on the graph) is the median ranking, meaning half of other events measured higher, and half measured lower. For example, a fiftieth percentile measure on the Card Exchange factor means that in fifty percent of events, the average number of card exchanges per attendee per day was higher than in the current event. Heading 106 indicates what category these factors relate to. Other factors and other categories could be measured and reported, for example, any of the factors shown in FIG. 11.

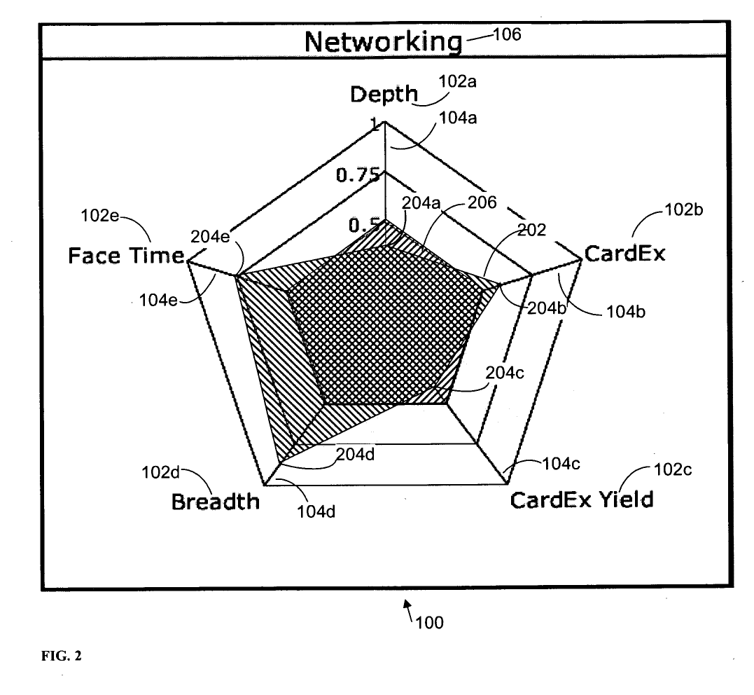

As shown in FIG. 2, to rapidly convey to the event organizer how the factors 102a-e for the current event compare to other events, a shaded region 202 is overlaid on the graph 100 connecting the points 204a-e that are set by plotting the current ranking of each factor 102a-e on its corresponding spoke 104a-e. This information can be updated continuously, i.e., as often as new data is available. Since the factors graphed in this example relate to exchanges between attendees, this shaded region 202 is referred to as the “networking profile” of this particular event. To allow rapid comparison, a pre-defined shaded region 206 reflects an “average” event, where all of the vital signs rated the median value.

Analysis of past events, for which an overall attendee satisfaction rating or other measurement is available, such as the “% Overall Excellent” factor in FIG. 11, can be used to show an event organizer which factors are important to that measurement. Inferences can then be drawn about what that overall measurement will be for the current event based on the same factors. First, a measurement is identified, such as overall satisfaction. Attendees for whom the measurement had the desired value are identified. The values of the available factors based on these attendees are compared to the values of those factors based on other attendees. Significant differences between the two groups in a particular factor suggest that those factors correlate to the overall measurement.

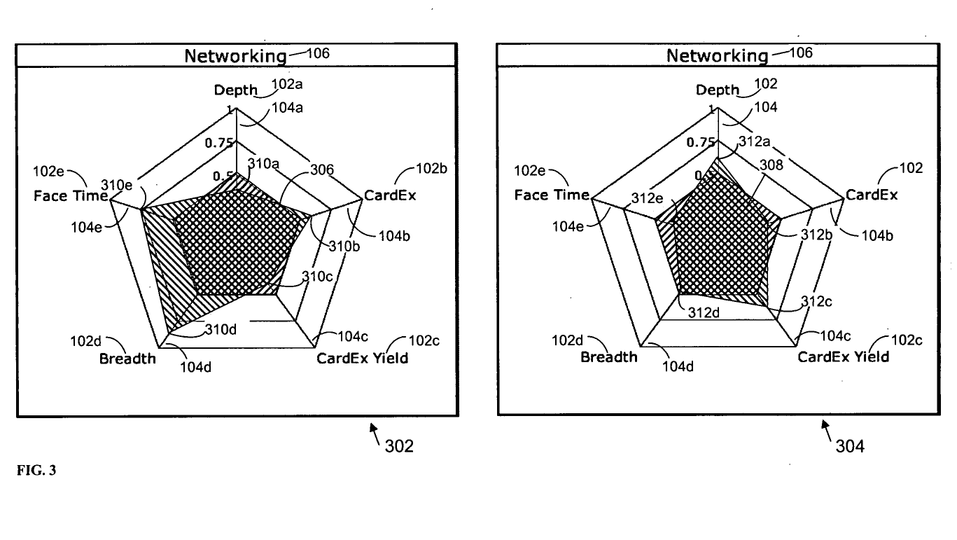

For example, as shown in FIG. 3, 60 percent of attendees at a conference were highly satisfied. The two graphs 302 and 304 compare the values of selected factors for the highly satisfied participants to the values for the other 40 percent of participants. In the first graph 302, a shaded region 306 defined by points 310a-e shows that the highly satisfied participants had a higher average number of card exchanges per day than the other participants, when compared to the shaded region 308 defined by points 312a-e in the second graph 304. This indicates that a high number card exchanges is correlated to high satisfaction with the event. An organizer who wants highly satisfied attendees may therefore want to take steps that will result in the attendees having a higher number of card exchanges. Of course it is also possible that the high number of card exchanges results from one of the other factors that is different between the two groups, such as the number of different people spoken to (breadth) and amount of time spent speaking to each of them (face time).

A similar analysis of attendance at sessions or workshops might indicate, for example, that the highly satisfied attendees had a higher “net positive” rating than the others, while both groups had a high attendance rate. This would imply that actual attendance rate is not as important as making sure that at least some sessions produce a very positive experience.

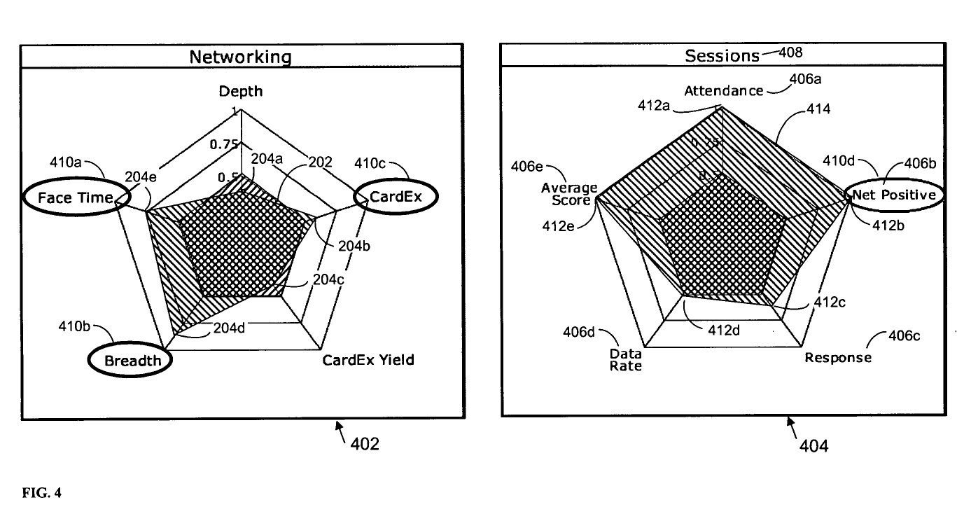

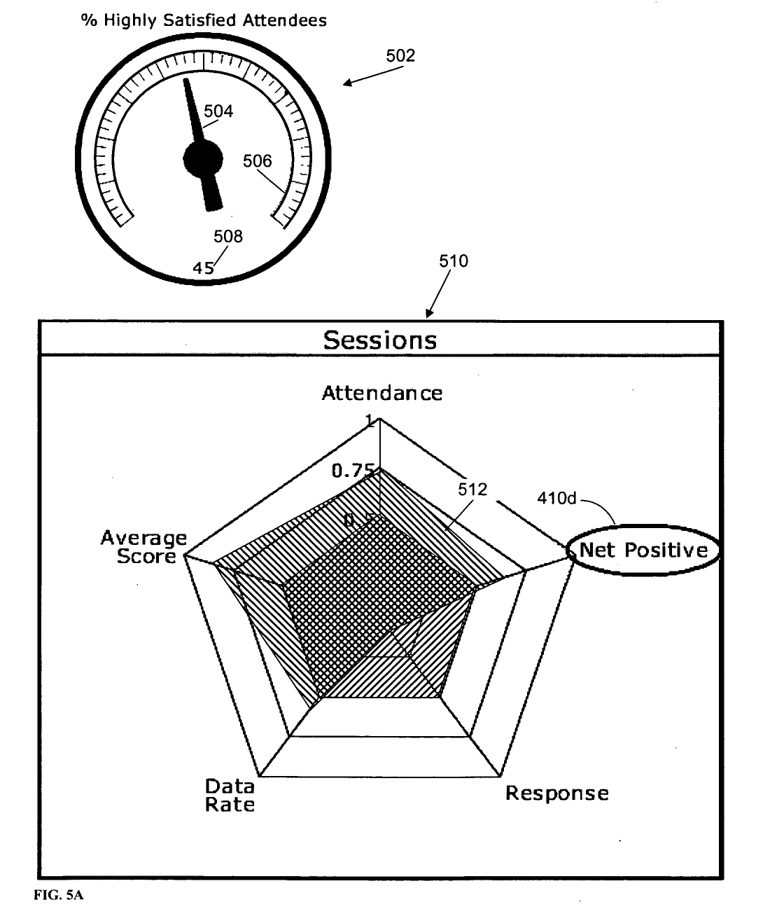

Once this analysis has been performed for past events and important factors identified, a display is tailored to the specific measurements that an event organizer want to maximize. As shown in FIG. 4, in addition to displaying the current values for each factor, the graphs identify which factors have in the past correlated to the chosen measure. The five factors 102a-e relating to exchanges between attendees are used to create one graph 402, as in FIG. 2, while the five factors 406a-e pertaining to conference sessions, from Table 2, are used to create a second graph 404, with the label “sessions” 408 corresponding to the category to which the factors 406a-e belong. Face Time, Breadth, Card Exchanges, and Net Positives are highlighted by ovals 410a-d on the graphs, while the current values 204a-e and 412a-e for all the factors are displayed, creating shaded regions 202 and 414.

These graphs 402 and 404 show the organizers that while three of the factors that correlate to high satisfaction are well above average, one, Card Exchanges, is only slightly above the median. At the same time, two less important factors, that is, factors that don't correlate to high satisfaction, are also well above average, session attendance and average score. This might suggest to the event organizer that they need to introduce some incentive for attendees to not only meet (which Face Time and Breadth indicate they are doing), but to actually exchange cards, and that they can do so at the expense of session attendance, since keeping high won't do as much to improve satisfaction as improving the number of card exchanges.

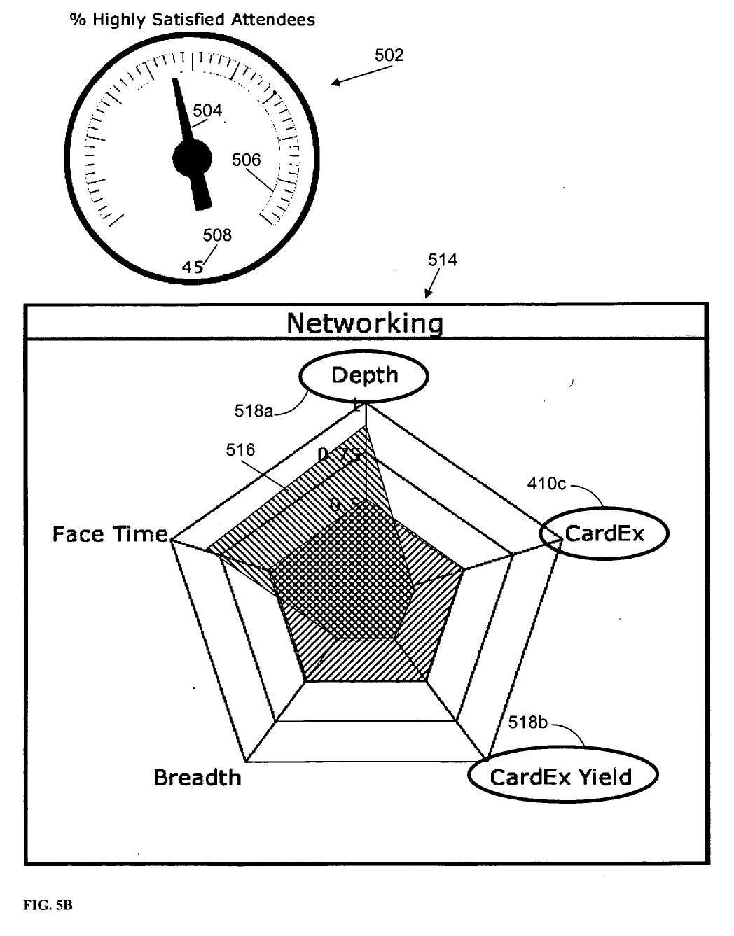

In other examples, as shown in FIGS. 5A and 5B, the current status of a set of factors can be used to predict a satisfaction measurement, such as the percentage of attendees who are highly satisfied. This is displayed using a speedometer-style graph 502 which uses a needle 504 and ring 506 to graphically display the percent satisfied 508.

In FIG. 5A, a graph 510 with a shaded region 512 indicates that only one factor 410d, Net Positive, is known to correlate to the percentage of attendees who are highly satisfied. That factor is slightly above the median, and the corresponding prediction that 45% of attendees will be highly satisfied is shown by the percent satisfied 508 in the graph 502. The availability of such information during an event, informing the organizer whether, for example, meeting sessions are contributing to satisfaction, can be very valuable. An organizer may realize that a certain type of session is proving more popular than another, and adjust their schedule on the fly to provide more sessions of that type. Similarly, the organizer may discover that certain groups of attendees are enjoying one type of session, while other groups are enjoying another type. The organizer could then re-arrange who is participating in upcoming events to assure that any remaining events are attended primarily by people who have been enjoying events of that type. These schedule updates could be communicated to the attendees and to those leading events through their badges, as described in the above-referenced applications.

In FIG. 5B, a graph 514 with a shaded region 516 indicates that for events of the same type as the event to which the data relates, three factors, Depth, Card Exchanges, and Card Exchange Yield, correlate to satisfaction by highlighting them with ovals 518a, 518b, and 410c. In this example, Depth is above the median, while Card Exchanges and Card Exchange Yield are both below the median. As a result, the graph 502 again shows that satisfaction is only predicted to be 45%. By increasing the number of cards exchanged by attendees, an organizer should be able to increase the percentage of attendees that are highly satisfied. Other factors could be displayed, for example a combination of networking and attendance related factors, and other types of visual displays could be used to display this information.

Another feature of the event management system is connections. One way that has been identified to improve attendee satisfaction is to encourage attendees to interact with each other. All of the factors in the Table 1 above relate to interactions between attendees. Based on the analysis of the correlation between the various factors and satisfaction or other overall measurements, an event organizer may want to specifically encourage interactions that are likely to produce longer conversations and more follow-up, rather than simply encouraging interactions in general. The connections feature facilitates this by identifying characteristics of the attendees and presenting the organizer with a user interface that allows him to query the attendees answers and to take actions to encourage attendees having certain characteristics to meet.

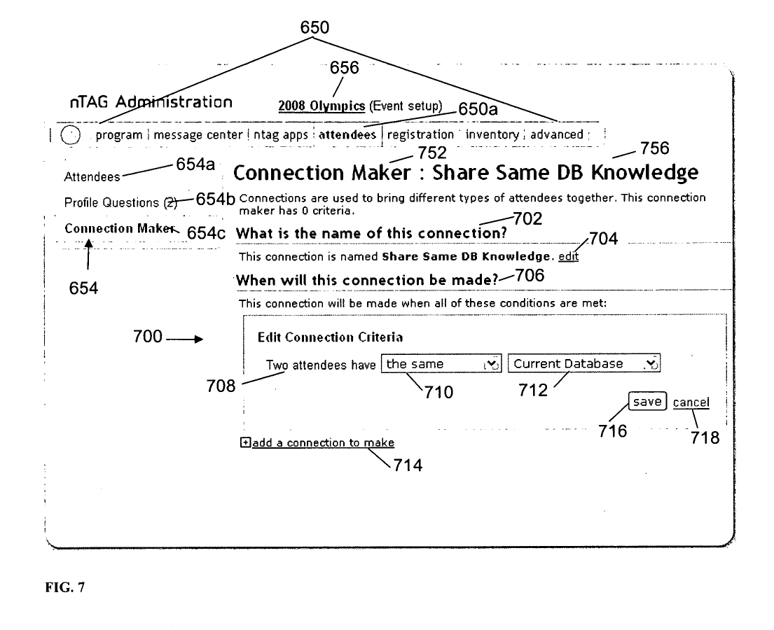

The user interface of the event management system can be presented to the event administrator, which may be the event organizer, through a web site as shown in FIGS. 6A, 6B, and 7. A row of tabs 650 presents the administrator with various functions, for example an “attendees” tab 650a. The functions associated with the other tabs shown are beyond the scope of this disclosure. A menu 654 lists options 654a-c available to the user within the current function. A title 652 (FIG. 6), 752 (FIG. 7) identifies which option the user is currently using. A event title 656 reminds the administrator what event he is working on.

As a first step in using the connections function, the event administrator creates profile questions by selecting the corresponding option (654b) from the menu 654. Profile questions identify attributes for each attendee, tailored to the specific event. In the example of FIG. 6A, a profile questions interface 600 includes a section 602 titled “Attendee Profile” in which two example profile questions 604a and 604b—“What database do you currently use at your enterprise?” and “When do you expect to upgrade your existing database?”—have been created. These two questions might be relevant to a sales event sponsored by a database vendor. The “edit” and “delete” links 606 and 608 allow the administrator to change or remove these questions, while the “create a profile question” link 610 allows the administrator to add an additional question. Another section 612, “Profile Status,” indicates how many attendees 616 fall into each of three status categories: those who haven't answered the profile questions (614a), those who have answered some of the questions (614b), and those who have answered them all (614c).

If the administrator follows the edit link 606, they are taken to a screen like that shown in the example of FIG. 6B. A title 652b indicates that the purpose of this page is to update a question. A configuration section 660 allows the administrator to specify a short name 662 for the question and the type of answer from a list box 664. In the example, “Pick Many” is selected from the list box 664. Other types of answers may include pick one, true/false, yes/no, or open-ended. An answers section 666 provides input boxes 668 for the administrator to specify potential answers.

Once profile questions have been defined for the event, the administrator can use the connections feature to define connections between attendees by selecting that option (654c). A connection is a set of rules that result in recommendations for attendees to meet other attendees or types of attendees at the event. Multiple potential connections can be created to encourage effective networking. In FIG. 7, a connection named “Share Same DB Knowledge” is being created such that when an attendee selects a specific answer to the selected profile question, other attendees who selected the same answer for that profile question are recommended to the attendee. A connections interface 700 includes two sections, the first section 702 titled “What is the name of this connection?” indicates what name the administrator has given the connection he is creating, and a link 704 allows the administrator to edit this name. The title 752 is modified to include additional information 756 reflecting the name of the current connection. A second section 706 titled “When will this connection be made?” displays the conditions that must be met for the present connection to be made. In this example, a single condition 708 consists of a relation 710 and a field, 712. The value selected for relation 710 is that the two attendees have the same value in the field 712. The value selected for field 712 is “current database,” the answer to the profile question 604a in FIG. 6. This means that any two attendees who provide the same answer to the question 604a will have the connection “Share Same DB Knowledge.”

The administrator can add additional criteria to the connection using the “edit” link 704. For example, the administrator could specify that in addition to using the same database, at least one of the attendees must have answered that he expects to upgrade his database within the next three months in response to the “Purchase Timeframe” profile question 604b. Other possible relations 710 include that the attendees have differing values for a field, or specific values, for example, both using Oracle, or one using Oracle and one using Sybase.

The “save” and “cancel” links 716 and 718 allow the administrator to save the connection they have created or cancel without creating or modifying the connection. The “add a connection to make” link 714 allows the administrator to create additional connections. Multiple connections can be created for an event to maximize networking recommendations for the attendees.

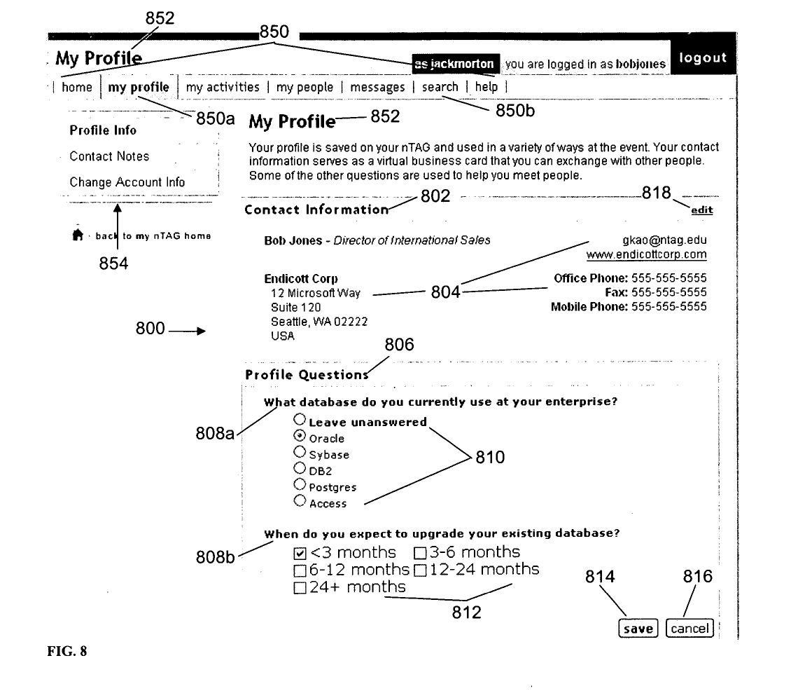

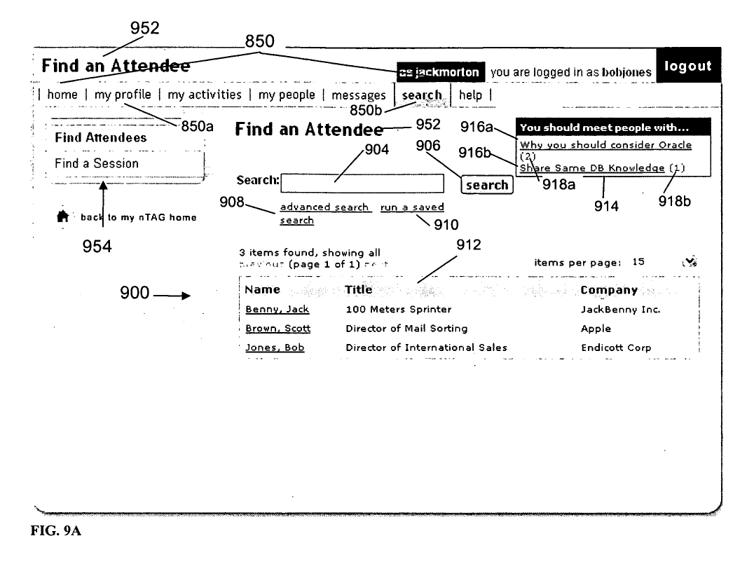

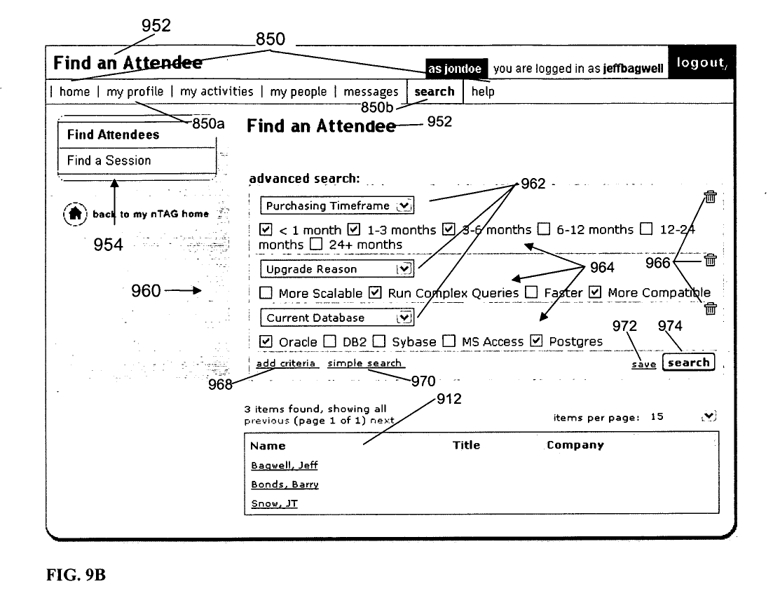

The event management system provides a personalized web site for each attendee to provide the attendee with information, tools, and resources pertaining to the event. Portions of this interface are shown in FIGS. 8, 9A, and 9B. As in FIGS. 6 and 7, a row of tabs 850 presents the attendee with various functions, for example a “my profile” tab 850a and a “search” tab 850b. The functions associated with the other tabs shown are beyond the scope of this disclosure. A menu of options 854 (FIG. 8), 954 (FIG. 9) lists options available to the user within each function. A title 852 (FIG. 8), 952 (FIG. 9) identifies which option the user is currently using.

Before the connections defined by the event administrator can function with respect to an attendee, the attendee must answer his profile questions, as shown in FIG. 8. When the attendee logs into his personalized website, he is presented with his profile questions in the profiles interface 800. A contact information section 802 shows information 804 that has already been entered, for example, in another part of the personalized website or by the event administrator, about the current attendee, while a profile questions section 806 presents the questions defined by the administrator in the profile questions interface 600. In this case, the first question 808a corresponds to profile question 604a (FIG. 6) and is presented as a multiple-choice question, where the attendee can specify only one of the potential answers 810. The second question 808b corresponds to profile question 604b and is presented in a way that allows the attendee to select more than one of the potential answers 812. The “save” and “cancel” buttons 814 and 816 allow the attendee to save his answers or cancel out of this screen. The “edit” link 818 allows the attendee to edit the information 804 shown in the contact information section 802.

Once connections are defined and attendees have entered profile information, connections that apply to an attendee appear in the attendee's search screen, as shown in FIG. 9A. When the attendee has chosen to search for other attendees, for example by using the “search” tab 850b at the top of the screen, he is presented with the search interface 900. The attendee can use a search box 904 to conduct a search for other attendees based on their contact information or their answers to the profile questions. “Search” button 906 executes the search specified in the search box 904, while the “advanced search” and “run a saved search” links 908 and 910 provide other functions. Since the attendee has not yet entered any search criteria, the interface displays all of the other attendees in the results list 912. When the attendee is using the search interface 900, a box 914 appears that recommends people he should meet. Two connections 916a and 916b are displayed. The “Share Same DB Knowledge” connection 916b is the connection defined in the example of FIG. 7. Parenthetical notations 918a and 918b after the connection titles 920a and 920b indicate how many attendees make the corresponding connection to the current attendee. Clicking on one of the connection titles 916a or 916b will cause the results list 912 to update to show those attendees.

Clicking on the advanced search link 908 takes an attendee to the advanced search interface 960 shown in FIG. 9B, which allows an attendee to search for other attendees based on demographic information and any profile information they have provided. The advanced search interface 960 allows the attendee to select profile questions 962. By specifying particular answers 964 to the selected profile questions 962, the attendee can search for other attendees that answered the selected profile questions 962 in the manner specified. Trash can icons 966 allow the attendee to delete the corresponding question from the search criteria. The “add criteria” link 968 allows the attendee to select an additional profile question, for example demographic information, while the “simple search link 970 returns the attendee to the simple search interface 900 of FIG. 9A. The “save” link 972 saves the search criteria for later use, while the “search” button 974 executes the search immediately. Search results are again shown in the results list 912.

This technology is not limited to organized events, but could be applied to any number of situations, for example, tracking and optimizing the activities of students in a school or the interactions of workers in an office environment. Similarly, this technology is not limited to use with badges as the medium for collecting information and effecting the connections, for example, electronic devices such as cellular telephones and personal digital assistants may be used. Other embodiments are within the scope of the following claims.

What is claimed is:

1. A method comprising
through a user interface on a computer, enabling a user to define questions to be answered by attendees of an event, the answers to the questions being indicative of connections corresponding to pairs of attendees,
receiving answers to the questions from the attendees through a user interface on a computer, and
based on the answers, providing information to attendees through a computer to facilitate face-to-face interaction between the pairs of attendees.

2. A method comprising
through a user interface on a computer, enabling an attendee of an event to provide answers to questions, the answers being indicative of connections of attendees to other attendees of the event, and
enabling the attendees to view, through the user interface, connections of the attendee to other attendees who have been selected based on connections indicated by answers of the attendees to the questions.

3. A method comprising
through a user interface on a computer, enabling a user to define a putative connection between attendees of an event, the putative connection corresponding to an objective of the event, and
on a computer, determining actual connections between attendees of the event corresponding to the putative connection based on information provided by the attendees.

4. A method comprising
enabling a user, through a user interface on a computer, to define connections between attendees of an event that will enhance a measure of success of the event, and
based on the defined connections, causing electronic badges worn by the attendees at the event to facilitate the defined connections.

5. A method comprising
through a user interface on a computer, enabling a user to view a graphical device that is representative of a current satisfaction of attendees of an event based on two or more factors associated with satisfaction while the event is occurring.

6. The method of claim 5 in which the graphical device illustrates performance against the two or more factors in a single integrated graphical representation.

7. A method comprising
on a computer,
receiving an identification of a relationship between values,
receiving an identification of an attribute,
determining that a person is associated with a value of the attribute having the identified relationship, and
on the basis of the determination, identifying the person as belonging to a group.

8. The method of claim 7 in which the determining comprises determining that the person is associated with the same value of the attribute as another person.

9. The method of claim 7 in which the determining comprises determining that the person is associated with a different value of the attribute than another person.

10. The method of claim 7 in which the determining comprises determining that the person is associated with a specific value of the attribute.

11. The method of claim 10 in which the specific value of the attribute is based on a value of the attribute associated with another person.

12. A method comprising
on a computer,
providing a user interface that allows a user to
identify a relationship between values, and
identify a relationship.

13. A method comprising
on a computer,
providing a user interface that
allows a user to associate values of attributes with the user, and
displays to the user other users based on the values of attributes and on values of attributes associated with the other users.

14. A method comprising
on a computer,
receiving first information about behavior of people,
receiving second information about a correlation of behavior of people to a first measurement,
based on the first information and the second information, predicting a value of the first measurement, and
displaying the first information, the predicted value, and a relationship between the first information and the predicted value.

15. The method of claim 14 in which
the first information comprises at least two second measurements,
the second information comprises an indication that at least one of the second measurements is correlated to the first measurement, and
displaying the relationship comprises indicating which of the second measurements is correlated to the first measurement.

16. The method of claim 15 in which
the second information comprises an indication that on prior occasions,
groups of people were associated with at least two different values of the first measurement, and
the groups of people associated with different values of the first measurement were associated with different values of at least one of the second measurements.
